(19) United States
(12) Patent Application Publication
(10) Pub. No.: US 2026/0235473 A1
(43) Pub. Date: Aug. 13, 2026

(54) KNOCK DETECTION METHOD, KNOCK DETECTION DEVICE, GAS ENGINE

(71) Applicant: Caterpillar Energy Solutions GmbH, Mannheim (DE)

(72) Inventors: Darshit Shah, Baden-Württemberg (DE); Florian Schmitt, Mannheim (DE)

(21) Appl. No.: 19/148,080

(22) PCT Filed: Jan. 12, 2024
(86) PCT No.: PCT/EP2024/025018

§ 371 Date: Jul. 15, 2025

(30) Foreign Application Priority Data
Jan. 18, 2023 (GB) 2300740.4

(51) Int. Cl. G01M 15/05; F02D 41/22

(52) U.S. Cl. CPC G01M 15/05; F02D 41/22

(57) ABSTRACT

The present invention pertains to a knock detection method for a gas engine, comprising the steps of retrieving a gas engine vibration signal; characterizing the retrieved vibration signal to obtain a characterized signal; detecting a knocking signal by comparing the characterized signal to a predetermined threshold signal; and qualifying the detected knocking signal as indicating a true knocking event or a false positive knocking event, based on at least one further gas engine operation parameter.

### TECHNICAL FIELD

The present invention pertains to a knock detection method for a gas engine, comprising the steps of retrieving a gas engine vibration signal, characterizing the retrieved vibration signal to obtain a characterized signal, and detecting a knocking signal by comparing the characterized signal to a predetermined threshold signal. The present invention further pertains to a knock detection device suitable for carrying out the method steps. Further, the present invention pertains to a gas engine comprising such a knock detection device.

### TECHNOLOGICAL BACKGROUND

Knocking is an abnormal combustion phenomenon, which adversely affects gas engine performance, emissions, and service life. During normal combustion in a gas engine piston, the combustion flame originates from an ignition spark and propagates through compressed combustion gas as a turbulent flame front. In contrast, knocking events occur when combustion gas is ignited before it reaches its designated compression rate and before it is consumed by the flame front. At a knocking event, large pressure waves with amplitudes of several bars are created, causing high-frequency oscillations of the cylinder pressure, which causes vibrations and is audible as sound.

Generally, the knocking phenomenon is more likely during operation at higher power densities. Pistons operating close to this limit enable the highest possible thermal efficiency rendering it a desired operating point. However, if the limit is exceeded, knocking occurs, and the combustion knock causes severe damage to the engine components.

Therefore, a monitoring and protection approach is needed to detect combustion knock evets with very high accuracy and low processing requirements.

The knock detection method for a gas engine, the knock detection device and the gas engine of the present disclosure solve one or more problems set forth above.

### SUMMARY OF THE INVENTION

Starting from the prior art, it is an objective to reliably determine knock events in a gas engine while simultaneously avoiding false positive knock event determinations in a simple and cost-effective manner.

This objective is solved by means a knock detection method for a gas engine with the features of claim 1, a knock detection device with the features of claim 16, and a gas engine with the features of claim 17. Preferred embodiments are set forth in the present specification, the Figures as well as the dependent claims.

Accordingly, a knock detection method for a gas engine is provided. The method comprises the steps of retrieving a gas engine vibration signal, characterizing the retrieved vibration signal to obtain a characterized signal, detecting a knocking signal by comparing the characterized signal to a predetermined threshold signal, and qualifying that the detected knocking signal as indicating a true knocking event, based on at least one further gas engine operation parameter.

Furthermore, a knock detection device suitable for carrying out the method according to the present disclosure may be provided, comprising a sensor device, a signal processing device, and a control device.

Further, a gas engine may be provided, comprising a knock detection device according to the present disclosure.

### BRIEF DESCRIPTION OF THE DRAWINGS

The present disclosure will be more readily appreciated by reference to the following detailed description when being considered in connection with the accompanying drawings in which:

Fig. schematically shows a flow chart of a knock detection method according to a first embodiment;

FIG. 2 schematically illustrates the step of signal retrieval according to an embodiment;

FIG. 3 schematically illustrates the step of signal characterization according to an embodiment;

FIG. 4 schematically shows a flow chart of a knock detection method according to a further embodiment;

FIG. 5 schematically shows a part of the qualifying step according to an embodiment; and

FIG. 6 schematically shows a flow chart of a knock detection method according to a further embodiment.

### DETAILED DESCRIPTION OF PREFERRED EMBODIMENTS

In the following, the invention will be explained in more detail with reference to the accompanying figures. In the Figures, like elements are denoted by identical reference numerals and repeated description thereof may be omitted in order to avoid redundancies.

The present disclosure is generally directed towards a robust knock detection method for a gas engine, preferably comprising multiple gas engine cylinders. More specifically, the present disclosure is directed towards a knock detection method providing knock event detection for a wide range of cylinder configurations and a wide range of combustion gas compositions at a high degree of certainty, while minimizing false-positive knocking event detections.

Usually, when implementing a knock detection method into a gas engine, a compromise must be found between high and low knock detection sensitivity because a high knock detection sensitivity is usually associated with increased false-positive knock event detections.

The underlying principle of the present disclosure is based on a step-wise analysis of one or more gas engine vibration signals and suggests adding additional signal qualification considerations to an initial, sensor-based knocking signal detection. This approach is in stark contrast to the widely held but herewith overcome opinion that a higher success rate of knock detection warrants highly sensitive sensor data and/or high signal post-processing efforts.

In FIG. 1, a knock detection method for a gas engine is schematically shown by a flow chart according to a first embodiment. On starting the gas engine, the gas engine operating states may be monitored, and it may be determined, in which state the gas engine is currently operating. Further, information pertaining to gas engine piston position and/or the current cycle thereof may be retrieved, for example in the form of crankshaft angles and/or time stamps.

The knock detection method for the gas engine comprises the steps of retrieving S10 a gas engine vibration signal 12, characterizing S20 the retrieved vibration signal 12 to obtain a characterized signal 14, and detecting S30 a knocking signal 18 by comparing the characterized signal 14 to a predetermined threshold signal 16. Further, the knock detection method comprises the step of qualifying the detected knocking signal 18 as indicating a true knocking event or a false positive knocking event, based on at least one further gas engine operation parameter.

In the context of the present disclosure, a gas engine vibration signal 12 may represent a signal comprising frequencies and/or frequency bands. In the sense of the present disclosure, such frequencies may be in the range from 0.5 Hz to 12 kHz.

The gas engine vibration signal 12 may carry information pertaining to one or more cylinders. The gas engine vibration signal 12 may be understood as a raw signal comprising frequencies. For example, the gas engine vibration signal 12 may be understood as the entirety of vibration signals detected by one or more vibration sensors. The gas engine vibration signal 12 may be a continuous signal detected by one vibration sensor or may consist of several continuous signals detected by several vibration sensors 20.

Retrieving S10 the gas engine vibration signal 12 may occur continuously during operation of the gas engine. Retrieving S10 the gas engine vibration signal 12 may start after a certain gas engine speed threshold is reached during which knocking may occur. In this case, retrieving S10 the gas engine vibration signal 12 may be initiated once the gas engine crossed said gas engine speed threshold.

The knock detection method according to the present disclosure may be understood as an indirect knock detection method, meaning that the present knock detection method may be based on vibrations, or accelerations, of a gas engine housing rather than being based on properties taken from the combustion chamber directly, for example a pressure within the combustion chamber.

The retrieval step S10 may comprise retrieving the vibration signal 12 from a sensor device 20. The retrieval step S10 may comprise retrieving the vibration signal 12 from several sensor devices 20. The retrieval step S10 may comprise retrieving several vibration signals 12 from individual sensor devices 20.

The vibration sensor may be an active or a passive sensor. The vibration sensor may be an acoustic sensor. The sensor device 20 may comprise one or more vibration sensors mounted on an engine surface, capturing vibrations of a gas engine cylinder and transmitting the vibrations from the combustion chamber to a control unit. In particular, one vibration sensor may be used for one gas engine cylinder.

Alternatively, the sensor device 20 may comprise one vibration sensor capturing the gas engine vibration signal 12 for several gas engine cylinders. For example, two cylinders may share one vibration sensor.

In the sense of the present disclosure, the sensor device 20 may be configured to continuously sense vibrations during operation or after a gas engine speed threshold is reached or surpassed.

The output of the retrieval step S10 is the gas engine vibration signal 12. The gas engine vibration signal may be understood in its literal sense as comprising frequencies as raw data and/or as comprising a vibration signal profile.

In the sense of the present disclosure, during the characterizing S20 step, the one or more retrieved gas engine vibration signals 12 are assigned to gas engine cylinders, reduced in length, and patched to a new signal, the characterized signal 14.

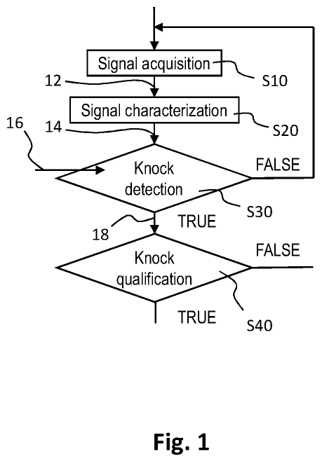

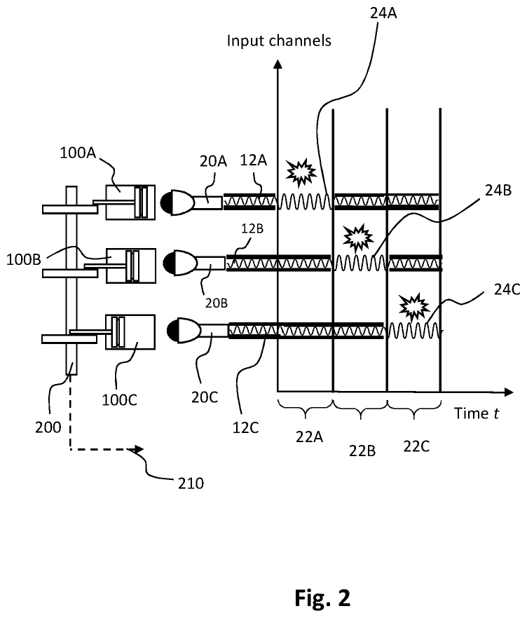

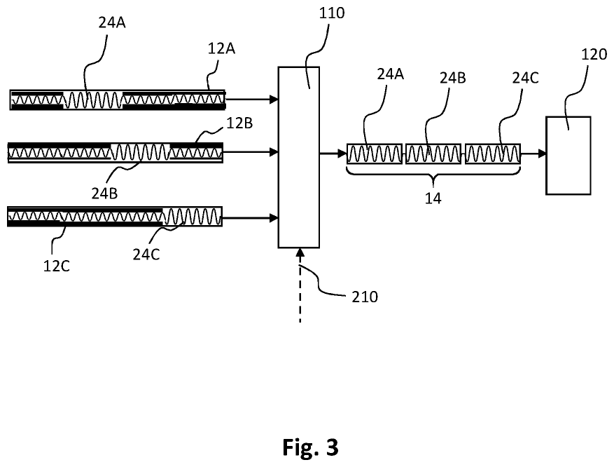

Assigning gas engine cylinders 100 to the one or more gas engine vibration signals 12 may be achieved by using information about the system architecture, c.f. explanations to FIG. 2 below. Reducing the one or more gas engine vibration signals in length may be achieved by shortening a signal by a time window, during which a given gas engine cylinder may experience a knocking event, c.f. explanations to FIG. 3 below, thereby achieving a knocking time window signal for a given gas engine cylinder.

Preferably, the characterization step may comprise identifying knocking time windows during which knocking may occur, knocking time window signals contained in said knocking time windows, and patching the knocking time window signals to one continuous characterized signal 14.

In the sense of the present disclosure, a knocking time window may be understood as the time span during which a given gas engine cylinder is exposed to the risk of a knock event, which is usually a time span reaching from shortly before the nominal ignition time to the nominal ignition time. The knocking time window may be a function of the gas engine cycle, for example the ignition time, piston rotation angle, or other combustion related parameters.

The predetermined threshold signal 16 may comprise, for each gas engine cylinder, a threshold amplitude for a given frequency, frequency range, or frequency band. The predetermined threshold signal 16 is to be defined such that a characterized signal 14 having an amplitude surpassing said threshold signal 16 amplitude is likely indicative of a knocking event.

The predetermined threshold signal 16 may be based on noise measurements and/or simulation data. Further, the predetermined threshold signal may comprise knocking time window information and/or a time stamp for synchronizing the predetermined threshold signal 16 with the characterized signal 14. Alternatively, or additionally, the predetermined threshold signal 16 may consist of several predetermined threshold signals 16, some of which may comprise threshold signals pertaining to one or just some cylinders of the total number of cylinders. In any case, the predetermined threshold signal 16 must comprise threshold information for all operated gas engine cylinders.

The threshold signal 16 preferably comprises a frequency sequence that allows direct comparison with the characterized signal 14. To this end, the sequence of the predetermined threshold signal 16 may be identical to the knocking time window sequence of the characterized signal 14.

The predetermined threshold signal 16 may be stored as a library or database. Preferably, the predetermined threshold signal 16 may be stored with references to the gas engine cylinders considered therein and a time stamp. Further, the predetermined threshold signal 16 may be stored in a look-up table.

In the context of the present disclosure, the gas engine vibration signal 12, the characterized signal 14, and the predetermined threshold signal 16 may have the same format and may be provided such that they are comparable to each other, for example by frequency.

The retrieved vibration signal 12 may have the form of a vibration signal profile. The vibration signal profile may extend over the time duration of the time window. The nominal operation vibration signal may also have the form of a vibration signal profile, of individual peaks, or it may be zero. Likewise, the predetermined threshold signal 16 may have the form of a signal profile or a constant signal.

The step of detecting S30 a knocking signal 18 by comparing the characterized signal 14 to the predetermined threshold signal 16 may be understood as a quantitative signal filtering step. The threshold signal 16 may be defined such a comparison of the characterized signal 14 with the threshold 16 indicates the possibility or likelihood of a knocking event. A detection of a knocking signal 18 may occur if the comparison gives the result that the predetermined threshold signal 16 was surpassed. In this case, the characterized signal 14 is graduated to a knocking signal 18. For example, if the comparison of the characterized signal 14 with the threshold signal 16 gives that the characterized signal 14 comprises a signal magnitude greater than the threshold 16, the characterized signal 14 is detected as a knocking signal 18. Likewise, if the comparison of the characterized signal 14 with the threshold signal 16 gives that the characterized signal 14 has a signal magnitude smaller than or equal to the threshold 16, the characterized signal 14 may be detected as a false knocking signal. In this case, according to the embodiment shown in FIG. 1, the method is looped back to the retrieval step S10, also called signal acquisition.

The knocking signal detection step S30 may be understood as a comparative step, comparing the characterized signal 14 to the predetermined threshold signal 16.

In the context of the present disclosure, detecting a knocking signal 18 in the detection step S30 alone is insufficient for identifying the knocking signal 18 as indicating a true knocking event. In other words, detecting a knocking signal 18 the detection step S30 only allows the conclusion that this signal has the potential for being indicative of a true knocking event, which is to be decided in the subsequent step, the qualification step S40.

In the qualification step S40, the detected knocking signal 18 is qualified either as indicative of a true knocking event or as a false positive knocking event, based on at least one further gas engine operation parameter.

In the context of the present disclosure, the qualification step S40 may be understood as a second instance check providing an additional decision-making layer.

In the context of the present disclosure, a further knock event dependent gas engine operation parameter may be any parameter that allows drawing a conclusion about whether a knocking event was plausible. This further knock event dependent gas engine operation parameter must not be the gas engine vibration signal 12 or the characterized signal 14 and may comprise a signal other than vibration.

In FIG. 2, the signal retrieval step according to an embodiment is schematically shown. The disclosure of FIG. 2 shall not be construed as being limited to aspects pertaining to the step of signal retrieval. Instead, some aspects of FIG. 2 may pertain to signal characterization.

In FIG. 2, a first gas engine cylinder 100A, a second gas engine cylinder 100B, and a third gas engine cylinder 100C are shown. Said gas engine cylinders 100A-C may be mounted to a crankshaft 200. A crankshaft signal 210 may be retrieved from the crankshaft 200, providing information about positions of the gas engine cylinders 100A-C mounted to the crankshaft 200. According to the embodiment shown in FIG. 2, a first sensor device 20A for the first gas engine cylinder 100A, a second sensor device 10B for the second gas engine cylinder 100B, and a third sensor device 10C for the third gas engine cylinder 100C may be provided. Said sensors 20A-C may be active or passive sensors.

According to the embodiment shown in FIG. 2, each sensor device 20A-C may provide a gas engine vibration signal 12A-C specific for its respective gas engine piston cylinder 100A-C. Accordingly, a first gas engine vibration signal 12A may be retrieved from the first sensor device 20A. The first gas engine vibration signal 12A therefore may provide a signal for the first gas engine cylinder 100A. Likewise, the second gas engine vibration signal 12B may be retrieved from the first sensor device 20B, and the third gas engine vibration signal 12C may be retrieved from the third sensor device 20C. The second and third gas engine vibration signals 12B, 12C therefore may provide a signal for the second and third gas engine cylinders 100B, 100C, correspondingly.

In the subsequent characterization step, a dedicated time window 22A-C may be identified for each gas engine cylinder 100A-C, corresponding to a time duration during which a knocking event is possible in a given gas engine cylinder. The graph in FIG. 2 illustrates the three gas engine vibration signals 12A-C as three separate input channels. Each gas engine vibration signal 12A-C may have a continuous signal in the shape of a varying frequency f. Further, each gas engine vibration signal 12A-C may comprise a knocking time window signal 24A-C, corresponding to a time duration during which the respective gas engine cylinder 100A-C may experience a knocking event. This time window usually covers the time shortly before and after combustion.

Thereby, it is possible to assign a short signal snippet, the knocking time window signal, of an individual signal to a specific gas engine piston 100A-C. Assigning knocking time windows to a gas engine piston is part of the signal characterization. Since the knocking time window may represent the only time duration during which knocking may occur in a given gas engine piston, it is thus possible to reduce the length of a gas engine vibration signal down to the length of a knocking time window, thereby achieving the knocking time window signal.

The person skilled in the art will appreciate that this may be achieved with a variety of alternative embodiments not shown in FIG. 2. For example, the number of gas engine pistons 100 may vary. Further, it may be possible that one sensor device 20 provides a gas engine vibration signal 12 which includes information for several gas engine pistons 100.

In FIG. 3, the step of signal characterization is shown according to an embodiment. The disclosure of FIG. 3 is not to be understood such as being limited to the step of signal characterization. Instead, some aspects of FIG. 3 may be attributed to the step of signal retrieval.

The illustrations and explanations provided in the context FIG. 3 are based on a signal retrieval according to the embodiment as shown in FIG. 2. Hence, three gas engine vibration signals 12A-C may be provided, each comprising a continuous signal of frequencies. The three gas engine vibration signals 12A-C may be input into a processing unit 110, which may also have the crankshaft signal 210 as a further input. Using the crankshaft signal 210, the processing unit 110 may be configured to identify the knocking time widow signals 24A-C for each gas engine cylinder 100A-C. Further, the processing unit 110 may be configured to cut and patch knocking time window signals 24A-C to one continuous signal, which is the characterized signal 14. Hence, the characterized signal 14 may be a “remix” of the three input signals, each of which being reduced in length to the length of the knocking time window for the induvial gas engine cylinder 100A-C. The input signals and the resulting characterized signal 14 may be comprise the raw frequencies as retrieved in the retrieval step. The knocking time window length may comprise one or more crankshaft angles. Optionally, a filter unit 120 may be provided, configured to apply one or more post-processing steps to the characterized signal 14.

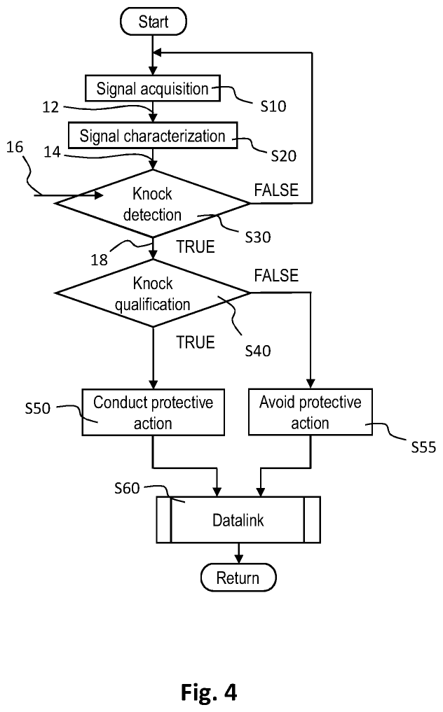

In FIG. 4, a knock detection method according to another embodiment is shown by a flow diagram. The embodiment shown in FIG. 4 fully incorporates the embodiment shown in FIG. 1. Accordingly, the principles, explanations, and definitions provided in the context of FIG. 1 also apply to the embodiment shown in FIG. 4 where applicable.

According to the embodiment shown in FIG. 4, the knocking detection method may further comprise a step of knock mitigation S50, if the detected knocking signal 18 is qualified S40 as indicating a true knocking event, and a step of avoiding knock mitigation S55 if the detected knocking signal 18 is qualified S40 as indicating a false positive knocking event.

Accordingly, the step of knock mitigation S50 may be connected to the “True” output of the qualification step S40 and the step of avoiding knock mitigation S55 may be connected to the “False” output of the qualification step S40.

During the step of knock mitigation S50, protective actions may be conducted, such as a reduction of power density, power, and/or relocating the combustion towards a different center of heat release, such that the knocking regime is avoided. During the step of avoiding knock mitigation S55, no action may be taken.

According to the embodiment shown in FIG. 4, the knocking detection method may further comprise a step of broadcasting S60, whether the detected knocking signal 18 is qualified as indicating a true knocking event or as indicating a false knocking event, via a CAN bus or a modbus and/or an ethernet for further usage.

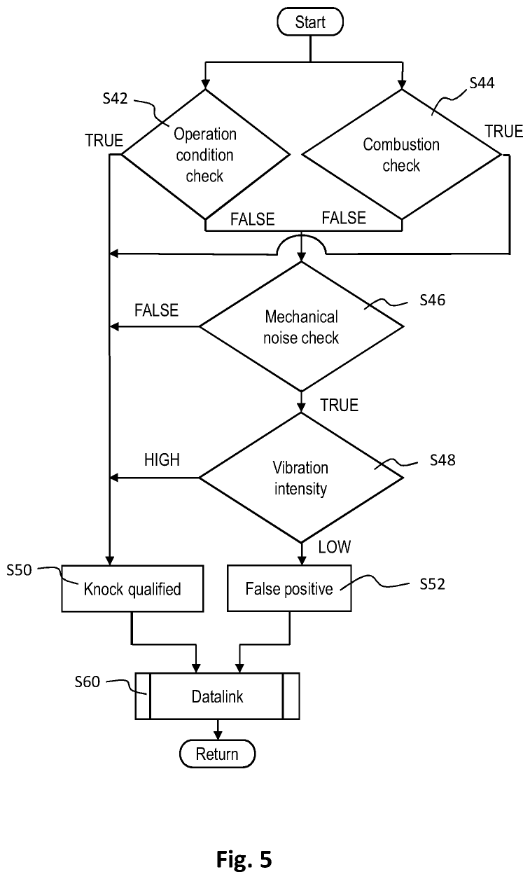

In FIG. 5, an example of a qualification step S40 is shown by a flow diagram. Accordingly, the qualification step S40 may comprise checking an operation condition check S42 to check if an operation parameter is within an acceptable range for a given gas engine power and operating state, and a combustion check S44 to check if a combustion parameter is in a critical range.

During the operation condition check S42 all cooling circuits and fluid temperatures may be monitored to get feedback on their state.

To this end, the operation parameter may comprise a water jacket inlet temperature, a water jacket outlet temperature, an intercooler inlet temperature, a lubrication oil temperature, and/or an intake air temperature.

For example, instantaneous sensor values for a jacket water temperature (inlet and outlet), an intercooler inlet temperature, a lubrication oil temperature and an intake air temperature may be compared on one end with a moving average value to check a trend. Consecutively, on the other end, a check may be conducted, checking if the value is within the acceptable range for a given engine power and operating state.

Further, estimations on the margins to the combustion knock may be estimated. The outcome of such estimations may be used to adjust certain key parameters based on a sensitivity analysis and test data based on combustion parameters of the gas engine.

This may be utilized to define a range for parameters like an intake manifold pressure, an intake manifold temperature, an air fuel ratio, a cylinder individual ignition angle and a boost pressure to indicate if any of the parameters are close to their critical levels that may induce the combustion knock.

Further, the combustion parameter may comprise an intake manifold pressure, an intake manifold temperature, an air fuel ratio, a cylinder individual ignition angle, and/or a boost pressure.

Thereby, the detected knocking signal 18 may be qualified S40 as indicating a true knocking event if the operation condition check S42 is true, and wherein the detected knocking signal 18 may be qualified as indicating a true knocking event if the combustion check S44 is true, and if either one of the operation condition check S42 and the combustion check S44 is false, a mechanical noise check S46 may be performed.

The mechanical noise check S46 may comprise identifying, if a predetermined noise source is a plausible source of the detected knocking signal 18, wherein, if the mechanical noise check S46 is negative, the detected knocking signal 18 may qualified as indicating a true knocking event.

Moreover, during the mechanical noise check 46 the algorithm may identify the mechanical noise sources that may interpreted as combustion knock owing to their time of occurrence, signal characteristic and signal frequency. Based on a structure analysis and firing order a time point for valve closure events (intake, exhaust) and a piston thrust direction change may be analyzed to identify the cylinders that are more prone to this noise sources.

To this end, the predetermined noise source may comprise a noise measurement and/or simulation data for a relevant gas engine cylinder and a relevant time window.

According to the embodiment shown in FIG. 5, if the mechanical noise check S46 is true, a vibration intensity check S48 may be performed, wherein, if the vibration intensity check S48 outputs a high intensity, the detected knocking signal 18 may qualified S40 as indicating a true knocking event.

Further, if the vibration intensity check S48 outputs a low intensity, the detected knocking signal 18 may be qualified as indicating a false positive knocking event.

An algorithm may proceed to the knock qualification step S40 to perform the operation condition check S42, the combustion check S44, and the mechanical noise check S46. Further, the algorithm may analyze a set of engine operation parameters that provide feedback on the current engine state when the knock was encountered and transmit a status flag further.

In general, the knock qualification step S40 may be activated when the engine is running in a mature operating state, above a defined speed threshold. The algorithm may conduct a qualification test for the detected knock event to check whether it is a correct detection caused by a combustion knock or is a false positive detection, where a similar vibration profile may be detected as knock without having any active combustion knock.

Further, when a knock event occurs, an algorithm used in the context of the knock detection method according to the present disclosure may conduct a comparison for the impacted cylinder with a look-up table and checked if one of the critical cylinders is currently in focus. However, a further analysis of the vibration intensity may be conducted by comparing it to a predetermined threshold to detect a false indication of the knock event and prohibit a control system from taking an action.

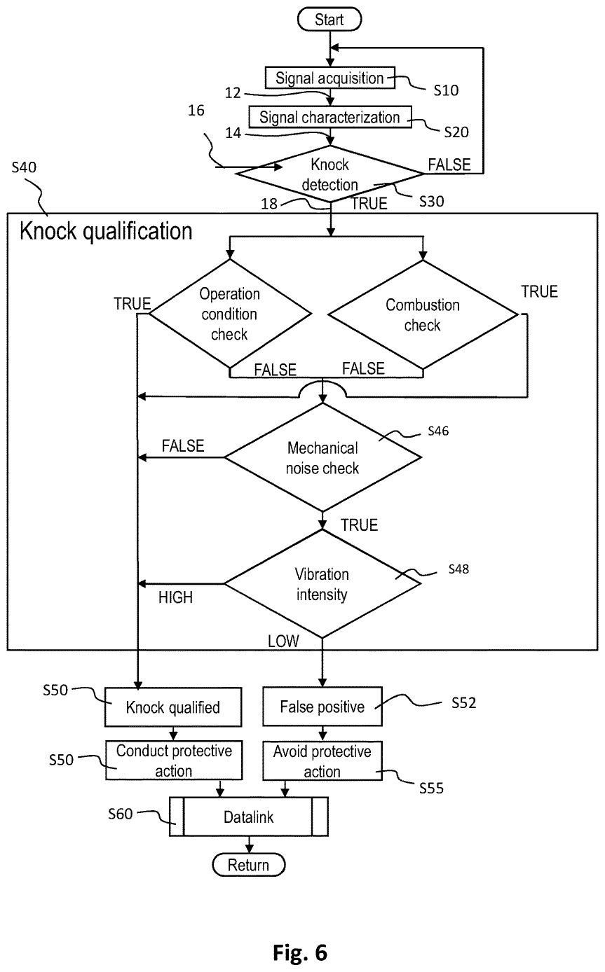

In FIG. 6, a knock detection method is schematically shown according to a further embodiment. The embodiment of FIG. 6 consists of a combination of the knock detection method as disclosed in the context of FIG. 2 and a knock detection method as disclosed in the context of FIG. 5. To this end, the same definitions, examples, and principles disclosed in the context of FIGS. 2 and 5 also apply to the embodiment shown in FIG. 6 where applicable.

It will be obvious for a person skilled in the art that these embodiments and items only depict examples of a plurality of possibilities.

Hence, the embodiments shown here should not be understood to form a limitation of these features and configurations. Any possible combination and configuration of the described features can be chosen according to the scope of the invention.

The knock detection method of the present disclosure generally relates to the detection of knocking events which may occur during the combustion cycle of gas engines, when the gas engine is operating in high power density ranges and when the knocking limit is breached. Especially newer gas engines are oftentimes designed to operate close to the knocking limit and must furthermore be able to operate using different gases as combustion gas. In addition, such gas engines must be able to be operated dynamically and deal with rapid changes in load and load dynamics.

To address these requirements, a knock detection method for a gas engine is provided, comprising the steps of retrieving a gas engine vibration signal, characterizing the retrieved vibration signal to obtain a characterized signal, detecting a knocking signal by comparing the characterized signal to a predetermined threshold signal, and qualifying the detected knocking signal as indicating a true knocking event or a false positive knocking event, based on at least one further gas engine operation parameter.

The knock detection method for a gas engine according to the present disclosure may be understood as an indirect knock detection method, meaning that instead of measuring parameters within the combustion chamber, gas engine housing accelerations, including accelerations caused by a knocking event, are measured.

By this, existing gas engines may be retrofitted with a knocking detection method according to the present disclosure. Further, utilizing such an indirect knock event detection method is cost-effective while at the same time overcoming the draw-back of inaccuracy as observed in conventional indirect knock detection methods.

The knock detection method of the present disclosure utilizes a stepwise approach of retrieving, knock characterization, and knock qualification. In other words, this approach allows to qualify whether a detected knocking signal is in fact indicating a true knocking event or rather indicating a false positive knocking event. Hence, the detected knocking signal must pass, after characterization, a further investigative qualification step before a true knocking event is determined. Thereby, the detection of a true positive knocking event is increased and the risk of detecting a false positive knocking event is reduced. Thereby, the gas engine may be operated close to its knocking limit with higher confidence, providing more work and less downtime.

According to a preferred embodiment of the knock detection method, the retrieval step may comprise acquiring the vibration signal from a sensor device.

The sensor device may be mounted on a gas engine surface, capturing all its vibrations, and transmitting the vibrations stemming from the combustion chamber. The sensor device may for example be a vibration sensor. In addition, a signal filtering technique may be used to identify the noise source. Identifying the noise source correctly allows avoiding a negative impact on engine's operation robustness, power availability, creating discomfort and operations issues for a customer.

The sensor device may be configured to always transmit the signals that may later be considered a qualified knocking signal after the gas engine exceeds a certain speed threshold. To this end, an algorithm may be activated once the gas engine crosses this speed threshold.

According to a preferred embodiment of the knock detection method, the characterization step may comprise identifying a relevant time window, wherein the characterization may be based on frequency bands.

According to a preferred embodiment of the knock detection method, the step of characterization may comprise post-processing the characterized signal using a filtering tool. Thereby, the characterized signal may be processed such that in the detection step, the comparison with the predetermined threshold signal is made easier.

With the features of this embodiment, it is possible to effectively shorten a detected vibration signal down to a signal of reduced length which is further matched with a corresponding operation vibration signal by frequency. Thereby, processing requirements may be reduced.

According to a preferred embodiment of the knock detection method, the characterization step may further comprise identifying knocking time windows, knocking time window signals contained therein, and patching the knocking time window signals to one continuous characterized signal.

Thereby, it is possible to reduce the retrieved signal to signal comprising only crucial parts for the subsequent detection step, allowing a faster comparison with the predetermined threshold signal.

According to a preferred embodiment of the knock detection method, the predetermined threshold signal may comprise historical and/or simulation data.

The predetermined threshold signal may comprise, or be based on, noises which may occur a knocking event of a given gas engine cylinder.

Preferably, the predetermined threshold signal comprises a database of possible noises for a given cylinder. The predetermined threshold may comprise data only for the knocking time windows of the gas engine cylinders. Thereby, the knock detection step may be conducted efficiently.

In the sense of the present disclosure, a knocking signal may be considered detected when an amplitude of a characterized signal surpasses a reference amplitude of the predetermined threshold signal.

This knocking signal detection occurs in the step of detecting a knocking signal by comparing the characterized signal to the threshold signal.

Because this may be indicative of a knocking event, such a characterized signal is graduated to a knock detection and is forwarded to the knocking event qualification step.

According to a preferred embodiment of the knock detection method, the qualification step may comprise checking an operation condition check to check if an operation parameter is within an acceptable range for a given gas engine power and operating state, and a combustion check to check if a combustion parameter is in a critical range.

In the qualification step, an algorithm proceeds to perform an operation condition check, and a combustion check. For example, the algorithm may analyze a set of gas engine operation parameters that provide feedback on the current engine state at the time the detected knocking signal was encountered. Those parameters must be dependent on a true knocking event, at least to some extent. Thereby, a further, independent knocking event investigation may be undertaken, allowing the conclusion whether a knocking event is plausible based on the detected knocking signal.

According to a further embodiment of the knocking detection method, the qualifying step may be activated when the gas engine is running in a mature operating state, above a predefined gas engine speed threshold. Thereby, the knock detection method may only be executed when there is a chance of a knocking event. Thereby, processing requirements and computing resources may be lowered, allowing a more cost-effective operation of the gas engine.

According to a further embodiment of the knock detection method, the operation parameter may comprise a water jacket inlet temperature, a water jacket outlet temperature, an intercooler inlet temperature, a lubrication oil temperature, and/or an intake air temperature.

For example, during the operation condition check, cooling circuits and fluid temperatures may be monitored to get a feedback on their state. Further, instantaneous sensor values for a jacket water temperature (inlet and outlet), an intercooler inlet temperature, a lubrication oil temperature and an intake air temperature may be compared on one end with a moving average to check a trend. Consecutively, on the other end, a check may be conducted if the value is within the acceptable range for a given engine power and operating state.

Moreover, while the combustion check may check an estimation on the margins to the combustion knock that may have been triggered via changes in certain key parameters, the latter may be adjusted using a sensitivity analysis and test data based on the combustion recipe of the given engine. This may be utilized to define a range of parameters, for example an intake manifold pressure, an intake manifold temperature, an air fuel ratio, a cylinder individual ignition angle, and a boost pressure to indicate if any of the parameters are close to their critical levels, which may have triggered the knocking event.

According to a further embodiment of the knock detection method, the combustion parameter may comprise an intake manifold pressure, an intake manifold temperature, an air fuel ratio, a cylinder individual ignition angle, and/or a boost pressure.

According to a further embodiment of the knock detection method, the detected knocking signal may be qualified as indicating a true knocking event if the operation condition check is true, wherein the detected knocking signal may be qualified as indicating a true knocking event, if the combustion check is true, and if either one of the operation condition check and the combustion check is false, a mechanical noise check is performed.

In other words, if both checks result “true”, a true knocking event during combustion is plausible. In this case, the previously detected knocking signal is qualified as indicating a true knocking event, because it is both exceeding all known nominal operation noises and because, in addition thereto, operation conditions and combustion conditions are both in a range where a knocking event is in fact plausible. If one of the operation condition check and the combustion check results “false”, further investigation is needed. In this case, the method proceeds to the mechanical noise check.

According to a further embodiment of the knock detection method, the mechanical noise check may comprise identifying, if a predetermined noise source is a plausible source of the detected knocking signal, wherein, if the mechanical noise check is negative, the detected knocking signal is qualified as indicating a true knocking event.

During the mechanical noise check, the algorithm may identify mechanical noise sources that may be interpreted as combustion knock owing to their time of occurrence, signal characteristic and signal frequency.

According to a further embodiment of the knock detection method, the predetermined noise source may comprise a noise measurement and/or simulation data for a gas engine component, in particular a relevant gas engine cylinder, and a relevant time window.

For example, based on structure analysis and firing order a time point for a valve closure events (intake, exhaust) and a piston thrust direction change may be analyzed to identify the cylinders that are more prone to this noise sources. However, also other mechanical components may be included such as an oil pump, and/or an externally triggered cooling water pump, without being limited thereto.

In general, during the mechanical noise check, all known potential noise sources for the time window of the detected knock signal may be considered. Where possible, the mechanical noise check may be performed specifically more cylinders but cylinder specific. Thereby, it may for example be found that the detected knocking signal originated from a neighboring cylinder instead of the cylinder in focus. Thereby, it may be determined if a knocking event is plausible based on the detected knocking signal.

According to a further embodiment of the knock detection method, if the mechanical noise check is true, a vibration intensity check may be performed, wherein, if the vibration intensity check outputs a high intensity, the detected knocking signal may be qualified as indicating a true knocking event.

During this check, it is analyzed if data exists that is indicative of an increased noise sensitivity for a given cylinder. For example, historic operation, maintenance, or replacement information may be considered. Based on this information, it is possible to quantify the intensity of the detected knocking signal relative to a cylinder specific noise characteristic. In other words, a given detected knocking signal may be considered a high intensity vibration signal for one cylinder, whereas the same detected knocking signal may be considered a low intensity vibration signal for another cylinder, due to different cylinder noise characteristics.

According to a further embodiment of the knock detection method, if the vibration intensity check outputs a low intensity, the detected knocking signal may be qualified as indicating a false knocking event. Thereby, false positive knocking event detections can be avoided effectively.

According to a further embodiment of the knock detection method, the knock detection method may further comprise a step of knock mitigation, if the detected knocking signal is qualified as indicating a true knocking event, and a step of avoiding knock mitigation if the detected knocking signal is qualified as indicating a false positive knocking event. Knock mitigation may be any action suitable to avoid combustion knocking events, for example reduction of the gas engine power output, or moving the combustion to a regime which is less prone to combustion knocking events. Such counter measures are important to avoid knocking event inherent gas engine damages. At the same time, avoiding knock mitigation measures when the detected knocking signal is qualified as indicating a false positive knocking event has the advantage that unnecessary power reductions and gas engine downtime may be avoided. Thereby, gas engine operation and availability can be maximized.

According to a further embodiment of the knock detection method, the knock detection method may further comprise the step of broadcasting, whether the detected knocking signal is qualified as indicating a true knocking event or a false knocking event, via a CAN bus or a modbus and/or an ethernet for further usage. Thereby, the obtained information may be stored, post-processed and/or used for subsequent operation gas engine operation cycles.

According to a further embodiment of the knock detection method, the nominal operation vibration signal and/or the predetermined noise source may be retrieved from a look-up table. Thereby, reference values may be provided in an easily accessible manner and may further be updated conveniently.

A knock detection device suitable for carrying out the method according to the present disclosure is provided, comprising a sensor device, a signal processing device, and a control device. Pertaining to the knock detection device, the same principles, explanations, and definitions provided in the context of the knock detection method apply where applicable. By the provision of a knock detection device according to the present disclosure, an existing gas engine, or gas engine infrastructure may be upgraded without introducing substantial changes to the gas engine.

A gas engine is provided, comprising at least one cylinder, a sensor device, a knock detection device according to the present disclosure, and a control device. Pertaining to gas engine, the same principles, explanations, and definitions provided in the context of the knock detection method and the knock detection device apply where applicable.

The sensor device may comprise a vibration sensor, which may be mounted to a gas engine surface, in particular the gas engine piston. Preferably, the sensor device may comprise a plurality of vibration sensors.

The control device may be configured to receive the signals and to execute the method steps. Further, the control device may comprise a data processing device suitable for post-processing signals.

According to an embodiment of the gas engine, the gas engine may further comprise at least one cooling circuit and means to monitor fluid temperatures within the cooling circuit. Further, the gas engine may comprise a water jacket having an inlet and an outlet as well as means to detect water jacket inlet and outlet temperatures.

According to a further embodiment, the gas engine may comprise an intercooler and an air intake comprising an intake manifold and means to detect an intercooler inlet temperature and an intake air temperature.

According to a further embodiment, the gas engine may comprise a CAN bus, a modbus, and/or an ethernet configured to broadcast information from the control device for further processing.

### INDUSTRIAL APPLICABILITY

With reference to the Figures, a knock detection method for a gas engine, a knock detection device, and a gas engine is provided.

In practice, a knock detection device and a gas engine according to the present disclosure may be manufactured, bought, or sold to retrofit a gas engine, or a gas engine already in the field in an aftermarket context, or alternatively may be manufactured, bought, sold, or otherwise obtained in an OEM (original equipment manufacturer) context. Likewise, the knock detection method according to the present disclosure can be implemented in an such a gas engine.

As alluded to previously herein, the aforementioned developments may provide a simple, cost-effective and reliably operating knock detection method for a gas engine.

Referring to FIG. 1, there is an embodiment shown disclosing a knock detection method for a gas engine, comprising the steps of retrieving a gas engine vibration signal, characterizing the retrieved vibration to obtain a characterized signal, detecting a knocking signal by comparing the characterized signal to a predetermined threshold signal, and qualifying the detected knocking signal as indicating a true knocking event or a false positive knocking event, based on at least one further gas engine operation parameter. One skilled in the art will expect that various developments of the present disclosure will cause an increased knock detection reliability and a reduced risk of false positive knock detection incidents when operating a gas engine. Thereby, necessitating less maintenance and allowing prolonged service life of the gas engine.

The same advantages apply to the remaining figures.

The present description is for illustrative purposes only and should not be construed to narrow the breadth of the present disclosure in any way. Thus, those skilled in the art will appreciate that various modifications might be made to the presently disclosed developments without departing from the full and fair scope and spirit of the present disclosure. Other aspects, features and advantages will be apparent upon an examination of the attached drawings and appended claims. As used herein, the articles “a” and “an” are intended to include one or more items and may be used interchangeably with “one or more.” Where only one item is intended, the term “one” or similar language is used. Also, as used herein, the terms “has,” “have,” “having,” “include”, “includes”, “including”, or the like are intended to be open-ended terms. Further, the phrase “based on” is intended to mean “based, at least in part, on” unless explicitly stated otherwise.

All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

Certain steps of any method may be omitted, performed in an order that is different than what has been specifically mentioned or in some cases performed simultaneously or in sub-steps. Furthermore, variations or modifications to certain aspects or features of various developments may be made to create further developments and features and aspects of various developments may be added to or substituted for other features or aspects of other developments in order to provide still further developments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A knock detection method for a gas engine, comprising the steps of:
retrieving a gas engine vibration signal;
characterizing the retrieved vibration signal to obtain a characterized signal,
detecting a knocking signal by comparing the characterized signal to a predetermined threshold signal;
characterized by:
qualifying the detected knocking signal as indicating a true knocking event or a false positive knocking event, based on at least one further gas engine operation parameter.

2. The knock detection method according to claim 1, wherein the retrieval step comprises retrieving the gas engine vibration signal from a sensor device.

3. The knock detection method according to claim 2, wherein the characterization step comprises identifying knocking time windows knocking time window signals contained therein, and patching the knocking time window signals to one continuous characterized signal.

4. The knocking method according to claim 2, wherein the predetermined threshold signal comprises a noise measurement and/or simulation data.

5. The knock detection method according to claim 1, wherein the qualification step comprises checking an operation condition check to check if an operation parameter is within an acceptable range for a given gas engine power and operating state, and a combustion check to check if a combustion parameter is in a critical range.

6. The knock detection method according to claim 5, wherein the operation parameter comprises a water jacket inlet temperature, a water jacket outlet temperature, an intercooler inlet temperature, a lubrication oil temperature, and/or an intake air temperature.

7. The knock detection method according to claim 5, wherein the combustion parameter comprises an intake manifold pressure, an intake manifold temperature, an air fuel ratio, a cylinder individual ignition angle, and/or a boost pressure.

8. The knock detection method according to claim 5, wherein the detected knocking signal is qualified as indicating a true knocking event if the operation condition check is true, and wherein the detected knocking signal is qualified as indicating a true knocking event if the combustion check is true, and if either one of the operation condition check and the combustion check is false, a mechanical noise check is performed.

9. The knocking detection method according to claim 8, wherein the mechanical noise check comprises identifying, if a predetermined noise source is a plausible source of the detected knocking signal wherein, if the mechanical noise check is negative, the detected knocking signal is qualified as indicating a true knocking event.

10. The knocking detection method according to claim 9, wherein the predetermined noise source comprises a noise measurement and/or simulation data for a relevant gas engine cylinder and a relevant time window.

11. The knocking detection method according to claim 8, wherein, if the mechanical noise check is true, a vibration intensity check is performed, wherein, if the vibration intensity check outputs a high intensity, the detected knocking signal is qualified as indicating a true knocking event.

12. The knocking detection method according to claim 11, wherein, if the vibration intensity check outputs a low intensity, the detected knocking signal is qualified as indicating a false positive knocking event.

13. The knocking detection method according to claim 1, further comprising a step of knock mitigation if the detected knocking signal is qualified as indicating a true knocking event, and a step of avoiding knock mitigation if the detected knocking signal is qualified as indicating a false positive knocking event.

14. The knocking detection method according to claim 1, further comprising the step of broadcasting whether the detected knocking signal is qualified as indicating a true knocking event or as indicating a false knocking event, via a CAN bus or a modbus and/or an ethernet for further usage.

15. The knocking detection method according to claim 1, wherein the nominal operation vibration signal and/or the predetermined noise source are retrieved from a look-up table.

16. A knock detection device suitable for carrying out the method according to claim 1, comprising a sensor device a signal processing device, and a control device.

17. A gas engine comprising at least one cylinder, a sensor device, a knock detection device according to claim 16, and a control device.
